(19) United States
(12) Patent Application Publication
(10) Pub. No.: US 2025/0342635 A1
(43) Pub. Date: Nov. 6, 2025

(54) REAL-TIME EXTRACTION OF 3D ANIMATION INFORMATION FROM PREDICTED SPEECH

(71) Applicant: Charter Communications Operating, LLC, St. Louis, MO (US)

(72) Inventors: Dell Lawrence Wolfensparger, Littleton, CO (US); Taylor Alexis Hicken, Littleton, CO (US)

(21) Appl. No.: 18/655,580

(22) Filed: May 6, 2024

(51) Int. Cl. G06T 13/20; G06T 13/40; G10L 15/02; G10L 15/18; G10L 15/187; G10L 25/63

(52) U.S. Cl. CPC G06T 13/205; G06T 13/40; G10L 15/02; G10L 15/1815; G10L 15/187; G10L 25/63; G10L 2015/025

(57) ABSTRACT

One or more inputs are processed with a machine-learned language model to obtain a prediction output. The inputs comprise speech information descriptive of one or more first words spoken by a user, and the prediction output comprises one or more second words predicted to follow the one or more first words. A sequence of visemes formed to produce the one or more second words is determined. Based on the sequence of visemes, facial animation information is generated descriptive of a facial animation that animates a three-dimensional representation of a mouth of the user forming the sequence of visemes to speak the one or more second words.

### BACKGROUND

Video-based communication has become an increasingly popular method of communication in recent years. For example, videoconferencing is widely used to conduct business transactions, legal proceedings, educational seminars, etc. In addition, video data has recently been utilized to power visual communications within virtual worlds. For example, by leveraging machine learning technologies, video data can be utilized to generate, and animate, virtual avatars to represent users in a personalized manner within a virtual world. When video capture is unavailable, such animated avatars can be used as replacements to maintain the immersion provided by a visual communication medium.

### SUMMARY

Implementations described herein enable real-time extraction of three-dimensional (3D) animation information from predicted speech. For example, the next words a user will speak can be predicted based on the most recent words spoken by the user. A sequence of visemes formed when the predicted words are produced can be identified. The sequence of visemes can be animated to generate the 3D animation information based on the predicted speech.

In one implementation, a method is provided. The method includes processing, by a computing system comprising one or more computing devices, one or more inputs with a machine-learned language model to obtain a prediction output, wherein the one or more inputs comprises speech information descriptive of one or more first words spoken by a user, and wherein the prediction output comprises one or more second words predicted to follow the one or more first words. The method includes determining, by the computing system, a sequence of visemes formed to produce the one or more second words. The method includes, based on the sequence of visemes, generating, by the computing system, facial animation information descriptive of a facial animation that animates a three-dimensional representation of a mouth of the user forming the sequence of visemes to speak the one or more second words.

In another implementation, a computing system is provided. The computing device includes a memory, and one or more processor devices coupled to the memory. The one or more processor devices are to process one or more inputs with a machine-learned language model to obtain a prediction output, wherein the one or more inputs comprises speech information descriptive of one or more first words spoken by a user, and wherein the prediction output comprises one or more second words predicted to follow the one or more first words. The one or more processor devices are further to determine a sequence of visemes formed to produce the one or more second words. The one or more processor devices are further to, based on the sequence of visemes, generate facial animation information descriptive of a facial animation that animates a three-dimensional representation of a mouth of the user forming the sequence of visemes to speak the one or more second words.

In another implementation, a non-transitory computer-readable storage medium is provided. The non-transitory computer-readable storage medium includes executable instructions to cause one or more processor devices to process one or more inputs with a machine-learned language model to obtain a prediction output, wherein the one or more inputs comprises speech information descriptive of one or more first words spoken by a user, and wherein the prediction output comprises one or more second words predicted to follow the one or more first words. The instructions further cause the one or more processor devices to determine a sequence of visemes formed to produce the one or more second words. The instructions further cause the one or more processor devices to, based on the sequence of visemes, generate facial animation information descriptive of a facial animation that animates a three-dimensional representation of a mouth of the user forming the sequence of visemes to speak the one or more second words. Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment suitable for implementing extraction of real-time three-dimensional (3D) animation information from predicted speech for video-based motion capture replacement according to some implementations of the present disclosure.

FIG. 2 is a block diagram of example contextual information elements according to some implementations of the present disclosure.

FIG. 3 is a block diagram for generating high-fidelity facial animation information according to some implementations of the present disclosure.

FIG. 4 depicts a flow chart diagram of an example method for real-time extraction of 3D animation information from predicted speech according to some implementations of the present disclosure.

FIG. 5 is a block diagram of the computing system suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and

B together.

As mentioned previously, video-based communication has become an increasingly popular method of communication in recent years. Video conferencing is widely used to conduct business transactions, legal proceedings, educational seminars, etc. In addition, video data can be utilized to power visual communications within virtual worlds. For example, by leveraging machine learning technologies, video data can be utilized to generate, and animate, virtual avatars to represent users in a personalized manner within a virtual world.

A major drawback to utilizing video-based communication technologies is the bandwidth necessary to enable such communications. Unlike audio-based communications, which only requires the transfer of audio data, video-based communications require the user to transmit hundreds of frames (e.g., images) every minute, which oftentimes possess high visual fidelity (e.g., resolution, lossless compression, etc.). As such, without a sufficiently strong network connection (e.g., a Fifth Generation (5G) New Radio (NR) connection, etc.), a user cannot reliably participate in video-based communications.

In addition, any fluctuations in the signal strength of a network connection can cause a user's video stream to temporarily cease transmission due to insufficient bandwidth. For example, assume that a smartphone device is connected to a high-speed network (e.g., 5G NR) and is being used to transmit a video stream to a videoconference session. If the network connection suffers any loss of signal strength (e.g., from traveling through a tunnel, switching to a different network node, leaving the area of service for a current network node, etc.), the video stream transmitted by the user can suffer severe loss of quality (e.g., stuttering, reduced resolution, packet loss, etc.) or can stop entirely.

However, substantial fluctuations in signal strength are relatively common in wireless networks, and even in wired networks, drops in service are to be expected. As such, many videoconference sessions include users that broadcast video streams with poor quality, which in turn can substantially degrade the videoconferencing experience for all users. Further, users with Internet Service Providers (ISPs) that charge additional fees for high bandwidth utilization often wish to avoid videoconferencing when possible. As such, techniques to reduce bandwidth utilization for videoconferencing are greatly desired.

Recently, virtual environments have been utilized in lieu of video communication when video communication fails (e.g., due to insufficient network strength or camera failure). More specifically, some attempts have been made to “replace” a user's video feed, when necessary, using a virtual avatar rendered in a virtual environment that closely mirrors the appearance of the user (e.g., a “meta” virtual world/universe, etc.). For example, if a user's camera fails during a videoconferencing session, the user's audio stream can continue transmitting while an avatar representation of the user is rendered in a three-dimensional environment. Conventionally, such avatars are designed to be visually similar to the user, and are capable of mimicking a generic speaking motion when the user speaks. By representing users with virtual avatars, such techniques can provide visual stimuli to the user in addition to the exchange of audio data, thus preserving some portion of the immersion offered by real-time videoconferencing.

However, there are several drawbacks to such approaches. First, conventional representations are commonly stylized in a “cartoon-like” manner with reduced visual fidelity because the techniques used to create them are generally incapable of creating “life-like,” or “photorealistic” representations. Users have indicated that conventional “low-fidelity” representations substantially degrade their communications experience. In particular, users have indicated that their immersion in a virtual conference is substantially degraded by when the animated mouth movements of a virtual avatar do not precisely mirror the mouth movements one would expect a user to make.

Some conventional approaches attempt to animate mouth movements by extracting motion capture information from the user's video stream. Unfortunately, extracting and using motion capture information to animate mouth movements and then rendering such movements in real-time is computationally complex, and thus difficult to perform without introducing perceptible delay between the user's voice and display of the animated mouth movements. This problem is exacerbated in scenarios where user video capture has failed. Specifically, while extracting motion capture information from video data can be somewhat successful in limited scenarios, these approaches cannot function when video capture fails. Thus, conventional animation techniques cannot be effectively leveraged to provide a replacement representation of a user in scenarios where video capture has failed without frustrating communication efforts and substantially degrading the user experience. Due to these deficiencies, when video communications fail, many users prefer to limit communications to the exchange of audio data rather than videoconference using virtualized representations.

Accordingly, implementations of the present disclosure propose extracting real-time three-dimensional (3D) animation information from predicted speech for video-based motion capture replacement. For example, assume that a user is transmitting audiovisual information via a camera and a microphone while participating in a videoconferencing session. Further assume that the user's camera fails while the microphone remains operational. A computing system (e.g., a system associated with the service provider for the videoconferencing session) can process the audio information with a speech recognition model to obtain speech information that includes a transcription of the words spoken by the user.

The computing system can process the speech information with a machine-learned language model to obtain a prediction output (e.g., a “next-word prediction”). The prediction output can indicate one or more words that are predicted to follow the words described by the speech information. In other words, the prediction output predicts what a speaking user will say next. For example, if the words transcribed by the speech recognition model are “let me take a seat in this,” the prediction output may include the word “chair” or “seat.”

The computing system can determine a sequence of phonemes based on the predicted words. Phonemes refer to discrete units of sound. Each of the predicted words can be spoken by producing one or more corresponding phonemes from the sequence of phonemes. For example, given the word “chair,” the computing system can extract a sequence of phonemes CH/A/R. For another example, given the word “sit,” the computing system can extract a sequence of phonemes S/I/T.

A viseme is the verbal equivalent of a phoneme, and represents a particular mouth shape and position when speaking. A person will typically form one or more visemes with their mouth when producing a phoneme. To follow the previous example, when speaking the word “chair,” the viseme formed by a user producing the CH and A phonemes is different than the viseme formed by the user producing the R phoneme.

When speaking the same language, different people will usually form the same visemes when producing the same phonemes. In other words, there is relatively little variation in the visemes formed by different people speaking the same words. Due to this lack of variation, accurately animating a mouth forming the sequence of visemes can provide a degree of realism sufficient to mitigate, or obviate, the drawbacks described previously.

As such, after extracting the sequence of phonemes from the words predicted to be spoken by the user, the computing system can map each of the phonemes to one or more corresponding visemes that are generally formed by people producing the phoneme. The computing system can generate facial animation information based on the sequence of visemes. The facial animation information can describe (e.g., via animation values, etc.) a facial animation that animates a three-dimensional representation of the mouth of the user forming the sequence of visemes to speak the one or more second words. In such fashion, implementations described herein can provide accurate and realistic visual representations sufficient to maintain user immersion without requiring access to video data.

Implementations of the present disclosure provide a number of technical effects and benefits. As one example technical effect and benefit, implementations of the present disclosure can substantially reduce overall network bandwidth utilization. For example, a conventional 4K resolution video stream provided by a user for videoconferencing can, on average, utilize sixteen gigabytes per hour. In turn, this substantial bandwidth utilization can reduce network capabilities for others sharing the same network. However, implementations of the present disclosure enable the generation and animation of photorealistic 3D representations of the faces of users. Unlike conventional videoconferencing, when utilizing the techniques described herein only audio data is necessary for transmission from the user device, which requires substantially less bandwidth than transmission of video data. In such fashion, implementations of the present disclosure substantially reduce bandwidth utilization in wireless networks while retaining the immersion and other benefits provided by conventional videoconferencing.

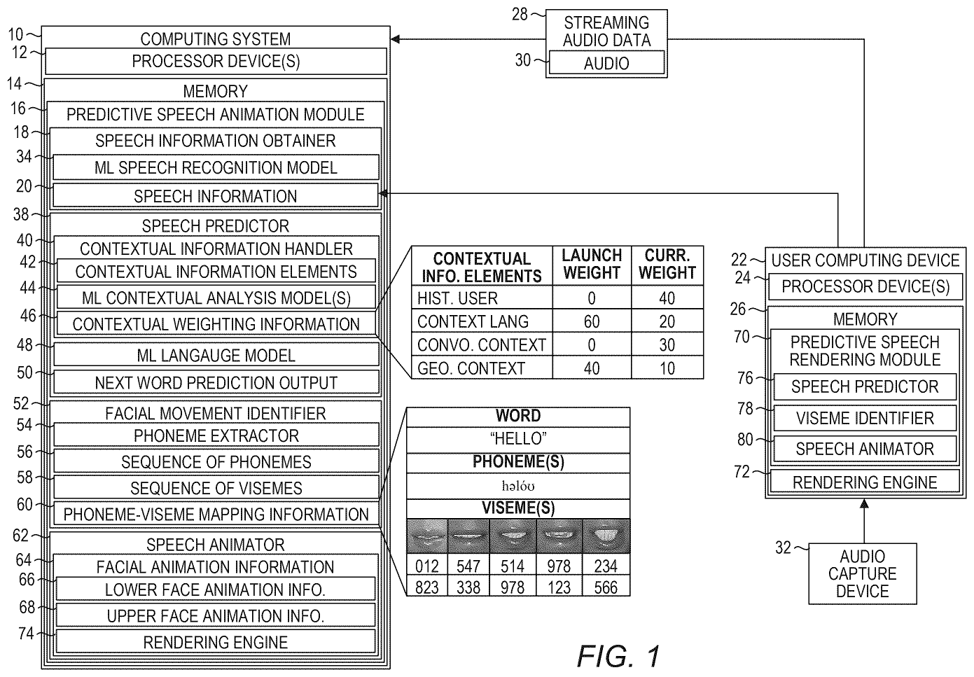

FIG. 1 is a block diagram of an environment suitable for implementing extraction of real-time three-dimensional (3D) animation information from predicted speech for video-based motion capture replacement according to some implementations of the present disclosure. A computing system 10 includes processor device(s) 12 and memory 14. In some implementations, the computing system 10 may be a computing system that includes multiple computing devices. Alternatively, in some implementations, the computing system 10 may be one or more computing devices within a computing environment that includes multiple distributed devices and/or systems. Similarly, the processor device(s) 12 may include any computing or electronic device capable of executing software instructions to implement the functionality described herein.

The memory 14 can be or otherwise include any device(s) capable of storing data, including, but not limited to, volatile memory (random access memory, etc.), non-volatile memory, storage device(s) (e.g., hard drive(s), solid state drive(s), etc.). In particular, the memory 14 can include a containerized unit of software instructions (i.e., a “packaged container”). The containerized unit of software instructions can collectively form a container that has been packaged using any type or manner of containerization technique.

The containerized unit of software instructions can include one or more applications, and can further implement any software or hardware necessary for execution of the containerized unit of software instructions within any type or manner of computing environment. For example, the containerized unit of software instructions can include software instructions that contain or otherwise implement all components necessary for process isolation in any environment (e.g., the application, dependencies, configuration files, libraries, relevant binaries, etc.).

The memory 14 can include a predictive speech animation module 16. The predictive speech animation module 16 can predict speech and animate predicted speech. The predictive speech animation module 16 can be, or otherwise include, any manner or collection of hardware (e.g., physical or virtualized) and/or software resources sufficient to implement the various implementations described herein. In particular, the facial representation module 16 can be utilized to generate animation information for a facial animation that animates a mouth of the user forming a sequence of predicted words, and can optimize, render, animate, etc. a photorealistic 3D representation of a face of the user using the animation information.

To do so, the predictive speech animation module 16 can include a speech information obtainer 18. The speech information obtainer 18 can obtain speech information 20. For example, the speech information obtainer 18 can obtain the speech information 20 from a user computing device 22. The user computing device 22 can be the computing device of a user participating in a communication session (e.g., videoconferencing, audio conferencing, multimedia conferencing (e.g., the exchange of both audio and video data), Augmented Reality/Virtual Reality (AR/VR) conferencing, etc.). The user computing device 22 can include processor device(s) 24 and memory 26 as described with regards to the processor device(s) 12 and the memory 14 of the computing system 10. In some implementations, the memory 26 of the user computing device 22 can include the predicted speech animation module 16, which will be discussed in greater detail at a subsequent point in the specification.

The speech information 20 can describe one or more first words spoken by the user of the user computing device 22. In some implementations, the speech information 20 can be obtained by first receiving streaming audio data 28 from the user computing device 22. The streaming audio data 28 can include audio 30 captured from an audio capture device 32 associated with the user computing device. For example, assume that the user of the user computing device 22 speaks the one or more first words into an audio capture device 32. The audio capture device 32 can capture the audio 30 produced by the user speaking the first words. The user computing device 22 can encode the audio 30 within the streaming audio data 28, and can transmit the streaming audio data 28 to the user computing device. Upon receipt of the streaming audio data 28, the speech information obtainer 18 can process the streaming audio data 28 with a machine-learned speech recognition model 34 to obtain the speech information 20.

Alternatively, in some implementations, the user computing device 22 can provide some, or all, of the speech information 20 to the user computing device directly. More specifically, in some implementations, the user computing device 22 can include a local speech information generator 36 that can perform the same functions described with regards to the speech information obtainer 18 of the predictive speech animation module 16. The local speech information generator 36 can include a machine-learned speech recognition model, and can use the model to process the streaming audio data 28 locally to generate some or all of the speech information 20. The locally generated speech information 20 can be proved to the computing system 10. In this manner, implementations described herein can more efficiently perform distributed computations by leveraging computational resources on local devices that would otherwise remain unutilized.

The predictive speech animation module 16 can include a speech predictor 38. The speech predictor 38 can predict the next word(s) to be spoken subsequent to the first words described by the speech information 20. For example, if the first words described by the speech information 20 include “what is your favorite,” the next words to be spoken can be predicted to be “animal,” “food,” “movie,” etc. The speech predictor 38 can predict speech based on a number of different inputs, including the speech information 20 and various contextual data elements (e.g., historical user information, conversational context information, etc.).

To do so, the speech predictor 38 can include a contextual information handler 40. The contextual information handler 40 can obtain, generate, catalogue, index, or otherwise manage contextual information elements 42. As described herein, a “contextual information element” generally refers to any type or manner of information that can be utilized as a contextual input for speech prediction. A contextual information element can be, or otherwise include, textual content, images, video, audio, sensor data, latent encoding data, etc. It should also be noted that the term “element” can refer to any type and/or quantity of information, and should not be interpreted as being limited to a single data object or “unit” of information. For example, a historical user information element which indicates historical speech patterns of the user may include multiple types of information from multiple sources (e.g., a latent encoding of prior conversations, an audio recording of a prior conversation, textual content describing words frequently spoken by the user, etc.).

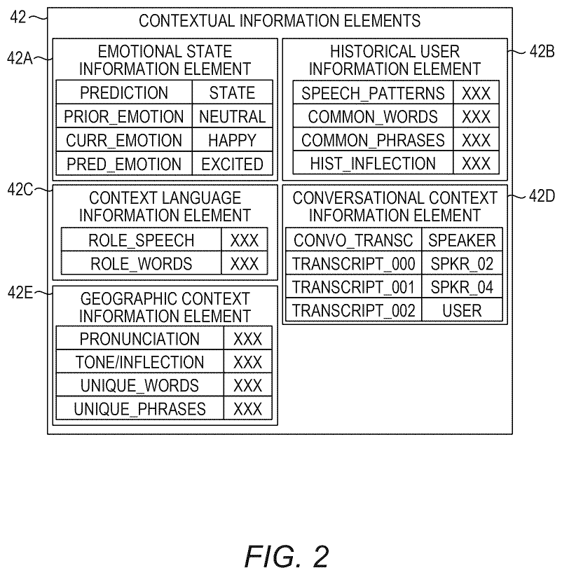

For a more specific example, turning to FIG. 2, FIG. 2 is a block diagram of example contextual information elements according to some implementations of the present disclosure. FIG. 2 will be discussed in conjunction with FIG. 1. Specifically, the contextual information elements 42, as depicted, can include an emotional state information element 42A. The emotional state information element 42A can describe a predicted emotional state of the user. In some implementations, the emotional state information element 42A can further describe predicted prior emotional state(s) of the user and a predicted future emotional state of the user. To follow the depicted example, the emotional state information element 42A can indicate that the user was recently “neutral,” is currently “happy,” and is likely to be “excited” in the future.

Specifically, the emotional state information element 42A can describe tones and inflections of a given user's conversation to determine the user's local present emotional state. Based on current emotional states or environments, individuals may interact differently with those around them. Once an emotional state is determined, it may be used to predict things such as the rate of speech, enunciation, cadence, and additional expressions and micro-expressions. For example, if a given person is speaking relatively loudly with negative tones and inflections, they may be found to have an angry emotional state, resulting in pre-determined facial contortions, or blend shapes, to be applied to their digital human representation. An angry emotional state may result in animations of the face that are consistent with widely recognized cultural expressions of an angry emotion, such as furrowed brows, narrowed eyes, or tense jaws and lips. Additionally, or alternatively, in some implementations, such an emotional state can result in a greater degree of facial expression (e.g., more extreme facial movements, or detailed facial movements, etc.), and vice-versa.

In some implementations, the emotional state information element 42A can be generated with a machine-learned model, such as a machine-learned sentiment analysis model. Specifically, in some implementations, the contextual information handler 40 can process the speech information 20 with a machine-learned sentiment analysis model to infer an emotional state of the user from the words that the user speaks. For example, if the words spoken by the user include “that's great news, this project will be a lot easier now,” the machine-learned sentiment analysis model can predict that the user is happy or excited.

Additionally, or alternatively, in some implementations, the contextual information handler 40 can generate the emotional state information element 42A by processing the streaming audio data 28 (e.g., with the same or a similar machine-learned sentiment analysis model). For example, the contextual information handler 40 can process the streaming audio data 28 with a model trained to identify a user's emotional state based on tone, inflection, word choice, prior conversational history, a predicted next word, historical user emotional information (e.g., information indicative of the user's prior emotional states, etc.), etc.

In some implementations, the contextual information elements can include a historical user information element 42B. The historical user information element 42B can indicate the user's historical speech patterns, word choice, commonly used phrases, and the like. For example, if the user has a habit of using a particular phrase, the historical user information element 42B can include or otherwise indicate that particular phrase. In some implementations, the historical user information element 42B can indicate differences between the user's speech patterns, word choice, phrase selection, etc. in comparison to a common “baseline.” For example, if the user has historically used a particular word, the historical user information element 42B can indicate a frequency at which the user uses that particular word relative to the “average” user (e.g., uses the word “ahoy” 90% more frequently than the average user, etc.). The historical user information element 42B can also indicate if the user uses a word less frequently than the “average” user (e.g., uses the word “howdy” 70% less than the average user etc.).

In some implementations, the historical user information element 42B can indicate speech patterns historically employed by the user. For example, historical user information element 42B can indicate whether the user has historically favored a certain sentence length, pauses during conversation, verbal cues (e.g., a grunt or humming sound to indicate agreement, etc.), etc. In some implementations, the historical user information element 42B can further indicate historical tone and inflection information. For example, the historical user information element 42B may indicate whether the user is likely to end a sentence with an upward inflection, use a certain tone, etc.

In some implementations, the contextual information elements 42 can include a context language information element 42C. The context language information element 42C can describe a particular role or purpose of the user and/or conversation to provide additional context. For example, if an ongoing conversation is a work conversation between the user and a coworker, the context language information element 42C can describe the user's role within the organization, the organization itself, the industry the user works in, and/or characteristics typical of users who fulfill that role (e.g., job responsibilities, educational attainment level, degree type, personality characteristics, etc.). Additionally, or alternatively, in some implementations, the context language information element 42C can indicate a degree of formality to be expected for the conversation.

Additionally, or alternatively, in some implementations, the context language information element 42C can describe linguistic patterns common among many users. Specifically, grammar is comprised of many different patterns that humans and machines can use to predict upcoming words in a sentence. For example, sentences are commonly structured as one of eight sentence patterns: subject-verb, subject-verb-object, subject-verb-adverb, subject-verb-adjective, etc. These patterns can be indicated by the context language information element 42C for predicting the next word spoken by the user. For example, if the first word in a sentence is “the”, then based on common grammatical rules described by the context language information element 42C, a noun is most likely to follow the word “the.”

The contextual information elements 42 can include a conversational context information element 42D. The conversational context information element 42D can describe an ongoing conversation in which the words captured in the audio 30 are spoken by the user. To follow the depicted example, the conversational context information element 42D can assign portions of a transcript of the conversation to particular speakers.

In some implementations, the contextual information elements 42 can include a geographic context information element 42E. The geographic context information element 42E can describe a geographic area that the user is associated with. More specifically, the geographic context information element 42E can describe linguistic characteristics associated with the geographic area that the user is associated with.

For example, if the user grew up in a particular geographic region known for a particular dialect, the geographic context information element 42E can associate the user with that particular dialect. In addition, the geographic context information element 42E can describe a tone, inflection, pronunciations, words, phrases, etc. that are commonly used by users who originate from that particular geographic region. For example, if the user is from the Midwest United States, the geographic context information element 42E can indicate that the user is likely to incorrectly use the word “pop” instead of correctly using the word “soda.” For another example, if the user is from the Midwest United States, the geographic context information element 42E can indicate that the user is likely to pronounce the word “bagel” as “bay-gel” rather than the correct pronunciation of “bah-gel.”

Returning to FIG. 1, the contextual information handler 40 can include machine-learned contextual analysis model(s) 44. The machine-learned contextual analysis model(s) 44 can be any type or manner of machine-learned model sufficient to obtain or generate some of the contextual information elements 42. In some implementations, the machine-learned contextual analysis model(s) 44 can include a machine-learned sentiment analysis model trained to process a transcript of a conversation (e.g., the conversation captured by the audio 30 of the streaming audio data 28) to determine an emotional state of the user and/or other participants in the conversation. Additionally, or alternatively, the machine-learned sentiment analysis model may be trained to process audio data directly (e.g., the streaming audio data 28) to determine the emotional state (e.g., based on inflection and tone captured in the streaming audio data 28, etc.).

In some implementations, the contextual information handler 40 can include contextual weighting information 46. The contextual weighting information 46 can describe weights to be applied to different elements of the contextual information elements 42 when the contextual information elements are utilized. Utilization of the contextual information elements, and the effect of the contextual weighting information 46 on such utilization, will be discussed in greater detail subsequently.

The speech predictor 38 can include a machine-learned language model 48. The machine-learned language model 48 can be a machine-learned model trained to process inputs to predict the next word(s) spoken by the user. Specifically, the machine-learned language model 48 can process the speech information 20 to obtain a next word prediction output 50 that is descriptive of one or more second words predicted to follow the first word(s) captured in the audio 30 (and thus described by the speech information 20). For example, if the speech information 20 is descriptive of the words “what is for dinner,” the next word prediction output 50 may describe the word “tonight” or “tomorrow.”

The machine-learned language model 48 can be any type or manner of model. For example, the machine-learned language model 48 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

Additionally, in some implementations, the machine-learned language model 48 can process one (or more) of the contextual information elements 42 alongside the speech information 20. In addition to the speech information 20, the contextual information elements 42 can provide additional context for the model to generate a more accurate next word prediction output 50. To follow the previous example in which the speech information 20 is descriptive of the words “what is for dinner,” if the contextual information elements 42 indicate that the current time for the user is 11 PM local time, next word prediction output 50 is likely to predict the word “tomorrow” to follow the first words rather than the word “today,” as it is most likely that the user has already eaten dinner.

In some implementations, the machine-learned language model 48 can process the contextual weighting information 46 alongside the contextual information elements 42 and the speech information 20. Alternatively, the machine-learned language model 48 can be reconfigured or otherwise modified based on the machine-learned language model 48 (e.g., by tuning hyperparameters, providing a supplemental instruction vector, etc.). For example, assume the machine-learned language model 48 is a Large Language Model (LLM) or similar Large Foundational Model (LFM) with behavior that can be modified via prompting. The speech predictor 38 can generate a prompt that instructs the machine-learned language model 48 to evaluate the contextual information elements 42 in accordance with the contextual weighting information 46.

In some implementations, the contextual weighting information 46 can be adjusted as a conversation occurs. As an example, assume that the user speaking has not previously spoken (in the current conversation or any prior recorded conversations), and as such, the historical user information element 42A is relatively sparse. The contextual weighting information 46 can weight the historical user information element 42A relatively low (e.g., a 0-10% weight, etc.). As the conversation continues, and information is added the historical user information element 42A, the contextual weighting information 46 can be adjusted to increase the weighting of the historical user information element 42A. In this manner, the computing system can ensure that the certain information elements are appropriately weighted based on the context of the conversation.

The machine-learned language model 48 can control the degree of influence exerted by particular information elements of the contextual information elements 42 in generating the next word prediction output 50.

The predictive speech animation module 16 can include a facial movement identifier 52. The facial movement identifier 52 can identify facial movements that correspond to the words described by the next word prediction output 50. More specifically, the facial movement identifier 52 can include a phoneme extractor 54. The phoneme extractor 54 can extract phonemes from the words described by the next word prediction output 50 to obtain a sequence of phonemes 56. Phonemes refer to discrete units of sound. Each word of the next word prediction output 50 can be spoken by producing one or more corresponding phonemes. For example, given the word “chair,” the computing system can extract a sequence of phonemes CH/A/R. For another example, given the word “sit,” the computing system can extract a sequence of phonemes S/I/T.

The facial movement identifier 52 can determine a sequence of visemes 58. The sequence of visemes 58 can correspond to the sequence of phonemes 56. A viseme refers to the verbal equivalent of a phoneme, and represents a particular mouth shape and position formed when producing a corresponding phoneme. A person will typically form one or more visemes with their mouth when producing a phoneme. Additionally, when speaking the same language, different people will usually form the same visemes when producing the same phonemes. In other words, there is relatively little variation in the visemes formed by different people speaking the same words. Due to this lack of variation, animating a mouth to form a sequence of visemes typically formed when producing a word can be highly realistic.

As such, after extracting the sequence of phonemes 56 from the next word prediction output 50, the facial movement identifier 52 can map each of the sequence of phonemes 56 to one or more corresponding visemes to obtain the sequence of visemes 58. Specifically, the facial movement identifier 52 can map the sequence of visemes 58 to the sequence of phonemes 56 based on phoneme-viseme mapping information 60. The phoneme-viseme mapping information 60 can describe the viseme(s) typically formed by the average user when producing a particular phoneme.

It should be noted that, while there are generally considered to be 44 phonemes in the English language, there are noticeably fewer visemes formed to produce those sounds. This is because the place of articulation (e.g., where the sound is made) is not visible when producing some phonemes. As such, some phoneme(s) of the sequence of phonemes 56 may not be mapped to any corresponding viseme of the sequence of visemes 58, while other phoneme(s) may be mapped to multiple visemes.

In some implementations, the sequence of phonemes 56 and/or the sequence of visemes 58 can be modified based on the contextual information elements 42. Specifically, expression of phonemes and/or visemes can vary based on the user's emotional state, the formality of the conversation, or other factors described by the contextual information elements 42, and these variations can be accounted for by modifying the sequence of phonemes 56 and/or the sequence of visemes 58 to reflect such factors. For example, an upset user may perform the same facial movements to produce a viseme as a calm user, but the upset user may perform the facial movements to a greater magnitude. The sequence of visemes 58 can be modified to indicate a greater magnitude of movement.

The computing system can include a speech animator 62. The speech animator 62 can generate facial animation information 64. The facial animation information 64 can animate a three-dimensional representation of mouth of the user forming the sequence of visemes 58 to speak the words predicted by the next word prediction output 50. The facial animation information 64 can be any type or manner of animation information, such as a script, animation values, instructions, etc.

The facial animation information 64 can animate a three-dimensional representation of a mouth of the user. Additionally, in some implementations, the facial animation information 64 can at least partially animate other portion(s) of the user's face, such as the user's eyes, forehead, cheeks, etc. In some implementations, the facial animation information 64 can animate three-dimensional representations of certain sub-surface anatomies of the user's face.

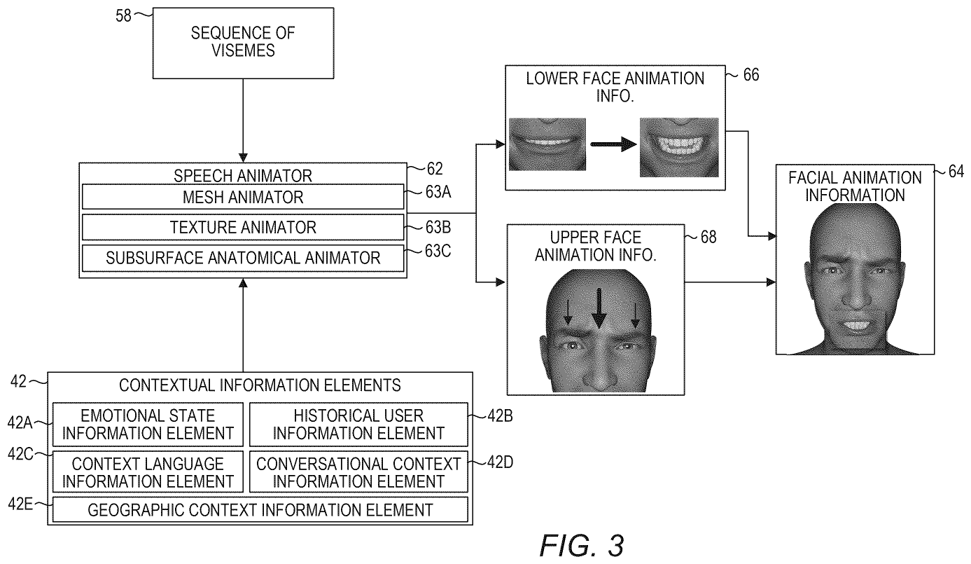

For a specific example, turning to FIG. 3, FIG. 3 is a block diagram for generating high-fidelity facial animation information according to some implementations of the present disclosure. FIG. 3 will be discussed in conjunction with FIGS. 1 and 2. Specifically, as illustrated, the speech animator 62 can process the sequence of visemes 58 along with some (or all) of the contextual information elements 42 to obtain the facial animation information 64.

In some implementations, the speech animator 62 can include a mesh animator 63A. The mesh animator 63A can animate a three-dimensional mesh face representation of the user's face. For example, the mesh animator 63A can process the sequence of visemes 58 and the emotional state information element 42A. For a first viseme of the sequence of visemes 58, the mesh animator 63A can generate a portion of the facial animation information 64 that animates the mesh representation of the user's mouth to replicate the viseme.

In some implementations, the speech animator 62 can animate portions of the three-dimensional representation of the user's face other than the mouth of the user. Specifically, in some implementations, contextual information elements 42 (e.g., emotional state information element 42A, conversational context information element 42D, etc.) can be used in determining facial animation values associated with portion(s) of the user's face other than the mouth. For example, if the emotional state information element 42A indicates that the user is in a happy emotional state, the facial animation information 64 may animate greater stretches of the corners of the user's mouth, or on the user's cheeks, to form a smile and a slight raise of the interior ends of the eyebrows. For another example, if the conversational context information element 42D indicates that the conversation is formal, there may be a reduced expressiveness applied to indicate a more serious cadence.

To follow the previous example, the portion of the facial animation information 64 that animates the mesh representation of the user's mouth to replicate the viseme can be stored as lower face animation information 66. The mesh animator 63A can then generate another portion of the facial animation information 64 that animates the mesh representation of other portion(s) of the user's face to move realistically while the viseme is replicated. If the emotional state information element 42A indicates that the user is sad, the mesh animator 63A can animate a mesh representation of the user's forehead to frown to reflect the emotional state of the user, and can store the animation as the upper face animation information 68.

In some implementations, the speech animator 62 can include a texture animator 63B. The texture animator 63B can animate textures applied to the mesh representation of the user's face to generate portion(s) of the facial animation information 64. For example, assume that the conversational context information element 42D indicates that the user is speaking at night. The texture animator 63B can animate the textures representing the user's face to reflect lighting and other characteristics of the texture to reflect the night-time conditions.

In some implementations, the speech animator 62 can include a subsurface anatomical animator 63C. The subsurface anatomical animator 63C can animate representations of sub-surface anatomies of the user's face (e.g., movements associated with a blood flow map, particular muscles of the user's face, particular facial features, etc.) to generate portion(s) of the facial animation information 64. In some implementations, the speech animator 62 can generate the facial animation information 64 to animate performance of certain microexpressions that are unique to the user. As described herein, a “microexpression” can refer to slight movements of the facial features of the user (e.g., slightly upturned lips, the user's eyes narrowing slightly, etc.).

To follow the depicted example, the speech animator 62 can generate lower face animation information 66. The lower face animation information 66 can animate the mouth of the user forming the visemes of the sequence of visemes 58. The speech animator 62 can also generate the upper face animation information 68. The upper face animation information 68 can animate other portions of the user's face to correspond to the animation described by the lower face animation information 66. Here, as depicted, the upper face animation information 68 can animate the user's brow furrowing. For example, if the emotional state information element 42A indicates that the user is angry, the upper face animation information 68 can animate the user's brow furrowing to convey the user's emotional state.

The upper face animation information 68 and the lower face animation information 66 can be combined to obtain the facial animation information 64. To follow the depicted example, the facial animation information 64 can animate both the user's brow furrowing and the user's mouth forming the sequence of visemes 58. In some implementations, the upper face animation information 68 and the lower face animation information 66 can be layered so that the animations are superimposed upon each other. It should be noted that the images within elements 64, 66, and 68 are included only to provide an illustrative example of the implementations described herein, and do not necessarily represent how animations described by the facial animation information 64 appear nor how they are rendered.

Returning to FIG. 1, in some implementations, the computing system 10 can provide the facial animation information 64 to the user computing device 22. Additionally, in some implementations, the computing system 10 can provide the facial animation information 64 to user computing devices associated with other users who are also participating in the conversation.

The user computing device 22 can include a predictive speech rendering module 70. The predictive speech rendering module 70 can include a rendering engine 72. The rendering engine 72 can render an animation of a three-dimensional representation of the user performing the animations described by the facial animation information 64. The rendering engine 72 can be any type or manner or rendering engine or pipeline.

Additionally, or alternatively, in some implementations, the speech animator 62 of the computing system 10 can include a remote rendering engine 74. The remote rendering engine 74 can perform some, or all, of the rendering tasks performed locally by the rendering engine 72 of the user computing device 22. For example, assume that the user computing device 22 is operating in a resource-constrained environment (e.g., low battery power, etc.). The remote rendering engine 74 can partially render some of the animation based on the facial animation information 64, and can provide the partially rendered animation to the user computing device 22 alongside a portion of the facial animation information 64 needed to complete the partially rendered animation.

It should be noted that some of the functionality attributed to the computing system 10 can be performed by the user computing device 22 to enable a distributed compute environment for more efficient utilization of available computing resources. Specifically, in some implementations, the predictive speech rendering module 70 can include a local speech predictor 76. The local speech predictor 76 can perform some, or all, of the functions described with regards to the speech predictor 38. The predictive speech rendering module 70 can also include a local facial movement identifier 78 and a local speech animator 80, which can perform some, or all, of the functions described with regards to the facial movement identifier 52 and the speech animator 62, respectively.

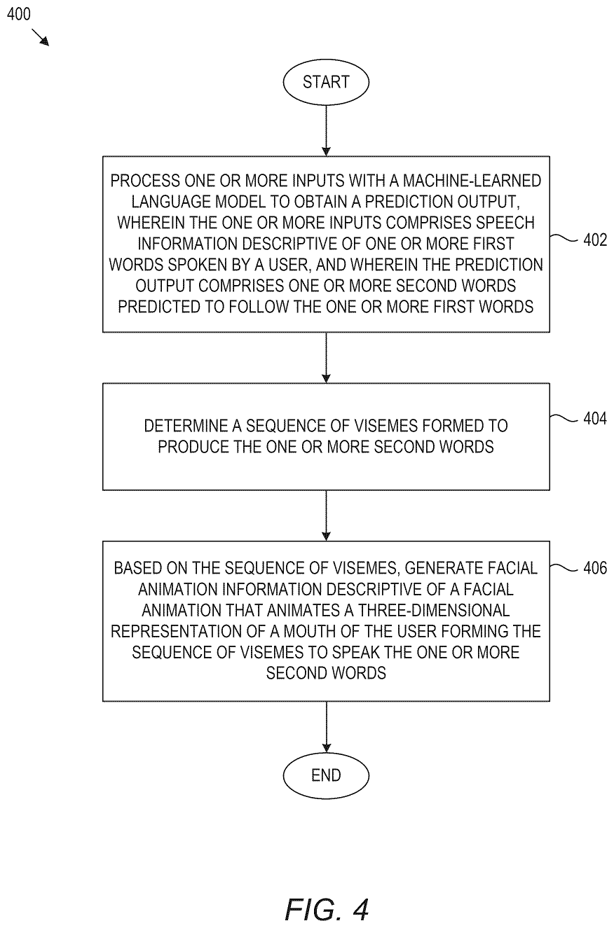

FIG. 4 depicts a flow chart diagram of an example method 400 for real-time extraction of 3D animation information from predicted speech according to some implementations of the present disclosure. Although FIG. 4 depicts steps performed in a particular order for purposes of illustration and discussion, the methods of the present disclosure are not limited to the particularly illustrated order or arrangement. The various steps of the method 400 can be omitted, rearranged, combined, and/or adapted in various ways without deviating from the scope of the present disclosure.

At 402, a computing system can process one or more inputs with a machine-learned language model to obtain a prediction output. The one or more inputs can include speech information descriptive of one or more first words spoken by a user. The prediction output can include one or more second words predicted to follow the one or more first words.

In some implementations, processing the one or more inputs with the machine-learned language model to obtain the prediction output can include processing the speech information and a plurality of contextual information elements with the machine-learned language model to obtain the prediction output. The plurality of contextual information elements can include at least one of an emotional state information element indicative of a predicted emotional state of the user, a historical user information element indicative of speech patterns of the user, a common language information element indicative of common language patterns, a conversational context information element indicative of words spoken by the user or other users prior to the one or more first words being spoken by the user, or a geographic context information element descriptive of a geographic area that the user is associated with.

In some implementations, the plurality of contextual information elements can include the geographic context information element descriptive of the geographic area that the user is associated with. The computing system can identify a synonym for a particular word of the one or more second words. The synonym can be associated with the geographic area that the user is associated with. The particular word can be associated with a second geographic area different than the first area. The computing system can replace the particular word with the synonym.

In some implementations, prior to processing the one or more inputs with the machine-learned language model to obtain the prediction output, the computing system can obtain, from a user device associated with the user, the speech information descriptive of the one or more first words spoken by the user from the user device. In some implementations, the computing system can receive streaming audio data from the user device that includes audio of the user speaking the one or more first words. The computing system can process the streaming audio data with a machine-learned speech recognition model to obtain a speech-to-text output comprising the speech information.

At 404, the computing system can determine a sequence of visemes formed to produce the one or more second words. In some implementations, determining the sequence of visemes formed to produce the one or more second words can include extracting the sequence of phonemes from the one or more second words predicted to follow the one or more first words. For each phoneme of the sequence of phonemes, the computing system can map the phoneme to one or more visemes of the sequence of visemes formed to produce the phoneme.

At 406, the computing system can, based on the sequence of visemes, generate facial animation information descriptive of a facial animation that animates a three-dimensional representation of a mouth of the user forming the sequence of visemes to speak the one or more second words. In some implementations, the computing system can provide the facial animation information to a user computing device associated with a second user different than the user.

In some implementations, the computing system can use the facial animation information to render at least some of the facial animation of the three-dimensional representation of the mouth of the user forming the sequence of visemes to speak the one or more second words. The computing system can provide the at least some of the facial animation to a user computing device associated with a second user different than the user.

In some implementations, the plurality of contextual information elements can include the emotional state information element indicative of the predicted emotional state of the user. Generating the facial animation information can include determining one or more facial movements indicative of the predicted emotional state of the user. Based on the predicted emotional state of the user, the computing system can generate a first portion of the facial animation information descriptive of a first portion of the facial animation that animates a three-dimensional representation of an upper facial region of a face of the user performing the one or more facial movements. Based on the sequence of visemes, the computing system can generate a second portion of the facial animation information descriptive of a second portion of the facial animation that animates the three-dimensional representation of the mouth of the user forming the sequence of visemes to speak the one or more second words.

In some implementations, prior to processing the one or more inputs with the machine-learned language model to obtain the prediction output, the computing system can process the speech information with a machine-learned sentiment analysis model to obtain the emotional state information element, The machine-learned sentiment analysis model can be trained to evaluate a tone of the user.

In some implementations, prior to processing the one or more inputs with the machine-learned language model to obtain the prediction output, the computing system can obtain contextual weighting information descriptive of a plurality of context weights respectively associated with the plurality of contextual information elements. The computing system can process the speech information and the plurality of contextual information elements with the machine-learned language model based at least in part on the plurality of context weights.

In some implementations, the computing system can determine one or more weight adjustments for the plurality of context weights. The computing system can determine the one or more weight adjustments for the plurality of context weights based on a difference between the one or more second words and one or more ground-truth second words. For example, the computing system can determine that the predicted next words are different than the words the user actually speaks. and can adjust the weights based on that difference. The computing system can apply the one or more weight adjustments to the plurality of context weights.

For another example, the computing system can determine a conversational length value indicative of a length of an ongoing conversation during which the user spoke the one or more first words. The computing system can determine the one or more weight adjustments for the plurality of context weights based on the conversational length value. For another example, the computing system can make a determination that the conversational length value is greater than a threshold value. Based on the determination, the computing system can determine the one or more weight adjustments for the plurality of context weight. The weight adjustment(s) can include a first weight adjustment to decrease a first context weight associated with the common language information element, and a second weight adjustment to increase a second context weight associated with the historical user information element indicative of the speech patterns of the user.

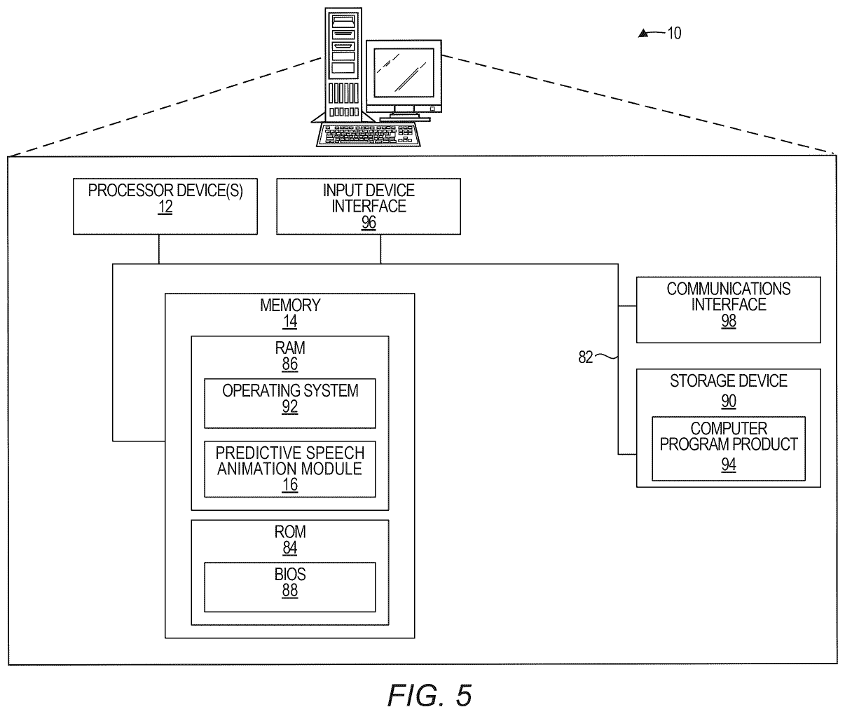

FIG. 5 is a block diagram of the computing system 10 suitable for implementing examples according to one example. The computing system 10 may comprise any computing or electronic device capable of including firmware, hardware, and/or executing software instructions to implement the functionality described herein, such as a computer server, a desktop computing device, a laptop computing device, a smartphone, a computing tablet, or the like. The computing system 10 includes the processor device(s) 12, the memory 14, and a system bus 82. The system bus 82 provides an interface for system components including, but not limited to, the memory 14 and the processor device(s) 12. The processor device(s) 12 can be any commercially available or proprietary processor.

The system bus 82 may be any of several types of bus structures that may further interconnect to a memory bus (with or without a memory controller), a peripheral bus, and/or a local bus using any of a variety of commercially available bus architectures. The memory 14 may include non-volatile memory 84 (e.g., read-only memory (ROM), erasable programmable read-only memory (EPROM), electrically erasable programmable read-only memory (EEPROM), etc.), and volatile memory 86 (e.g., random-access memory (RAM)). A basic input/output system (BIOS) 88 may be stored in the non-volatile memory 84 and can include the basic routines that help to transfer information between elements within the computing system 10. The volatile memory 86 may also include a high-speed RAM, such as static RAM, for caching data.

The computing system 10 may further include or be coupled to a non-transitory computer-readable storage medium such as the storage device 90, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 90 and other drives associated with computer-readable media and computer-usable media may provide non-volatile storage of data, data structures, computer-executable instructions, and the like.

A number of modules can be stored in the storage device 90 and in the volatile memory 86, including an operating system 92 and one or more program modules, such as the predictive speech animation module 16, which may implement the functionality described herein in whole or in part. All or a portion of the examples may be implemented as a computer program product 94 stored on a transitory or non-transitory computer-usable or computer-readable storage medium, such as the storage device 90, which includes complex programming instructions, such as complex computer-readable program code, to cause the processor device(s) 12 to carry out the steps described herein. Thus, the computer-readable program code can comprise software instructions for implementing the functionality of the examples described herein when executed on the processor device(s) 12. The processor device(s) 12, in conjunction with the predictive speech animation module 16 in the volatile memory 86, may serve as a controller, or control system, for the computing system 10 that is to implement the functionality described herein.

Because the predictive speech animation module 16 is a component of the computing system 10, functionality implemented by the predictive speech animation module 16 may be attributed to the computing system 10 generally. Moreover, in examples where the predictive speech animation module 16 comprises software instructions that program the processor device 12 to carry out functionality discussed herein, functionality implemented by the predictive speech animation module 16 may be attributed herein to the processor device(s) 12.

An operator, such as the user, may also be able to enter one or more configuration commands through a keyboard (not illustrated), a pointing device such as a mouse (not illustrated), or a touch-sensitive surface such as a display device. Such input devices may be connected to the processor device(s) 12 through an input device interface 96 that is coupled to the system bus 82 but can be connected by other interfaces such as a parallel port, an Institute of Electrical and Electronic Engineers (IEEE) 1394 serial port, a Universal Serial Bus (USB) port, an IR interface, and the like. The computing system 10 may also include the communications interface 98 suitable for communicating with the network as appropriate or desired. The computing system 10 may also include a video port configured to interface with a display device, to provide information to the user.

Individuals will recognize improvements and modifications to the preferred examples of the disclosure. All such improvements and modifications are considered within the scope of the concepts disclosed herein and the claims that follow.

What is claimed is:

1. A computer-implemented method comprising:
processing, by a computing system comprising one or more computing devices, one or more inputs with a machine-learned language model to obtain a prediction output, wherein the one or more inputs comprises speech information descriptive of one or more first words spoken by a user, and wherein the prediction output comprises one or more second words predicted to follow the one or more first words;
determining, by the computing system, a sequence of visemes formed to produce the one or more second words; and
based on the sequence of visemes, generating, by the computing system, facial animation information descriptive of a facial animation that animates a three-dimensional representation of a mouth of the user forming the sequence of visemes to speak the one or more second words.

2. The computer-implemented method of claim 1, wherein determining the sequence of visemes formed to produce the one or more second words comprises:
extracting, by the computing system, a sequence of phonemes from the one or more second words predicted to follow the one or more first words; and
for each phoneme of the sequence of phonemes:
mapping, by the computing system, the phoneme to one or more visemes of the sequence of visemes formed to produce the phoneme.

3. The computer-implemented method of claim 1, wherein the method further comprises:
providing, by the computing system, the facial animation information to a user computing device associated with a second user different than the user.

4. The computer-implemented method of claim 1, wherein the method further comprises:
using, by the computing system, the facial animation information to render at least some of the facial animation of the three-dimensional representation of the mouth of the user forming the sequence of visemes to speak the one or more second words; and
providing, by the computing system, the at least some of the facial animation to a user computing device associated with a second user different than the user.

5. The computer-implemented method of claim 1, wherein processing the one or more inputs with the machine-learned language model to obtain the prediction output comprises:
processing, by the computing system, the speech information and a plurality of contextual information elements with the machine-learned language model to obtain the prediction output descriptive of the one or more second words predicted to follow the one or more first words, and wherein the plurality of contextual information elements comprises at least one of:
an emotional state information element indicative of a predicted emotional state of the user;
a historical user information element indicative of speech patterns of the user;
a common language information element indicative of common language patterns;
a conversational context information element indicative of words spoken by the user or other users prior to the one or more first words being spoken by the user; or
a geographic context information element descriptive of a geographic area that the user is associated with.

6. The computer-implemented method of claim 5, wherein the plurality of contextual information elements comprises the emotional state information element indicative of the predicted emotional state of the user; and
wherein generating the facial animation information comprises:
determining, by the computing system, one or more facial movements indicative of the predicted emotional state of the user;
based on the predicted emotional state of the user, generating, by the computing system, a first portion of the facial animation information, wherein the first portion of the facial animation information is descriptive of a first portion of the facial animation that animates a three-dimensional representation of an upper facial region of a face of the user performing the one or more facial movements.

7. The computer-implemented method of claim 6, wherein generating the facial animation information further comprises:
based on the sequence of visemes, generating, by the computing system, a second portion of the facial animation information descriptive of a second portion of the facial animation that animates the three-dimensional representation of the mouth of the user forming the sequence of visemes to speak the one or more second words.

8. The computer-implemented method of claim 6, wherein, prior to processing the one or more inputs with the machine-learned language model to obtain the prediction output, the method comprises:
processing, by the computing system, the speech information with a machine-learned sentiment analysis model to obtain the emotional state information element, wherein the machine-learned sentiment analysis model is trained to evaluate a tone of the user.

9. The computer-implemented method of claim 5, wherein, prior to processing the one or more inputs with the machine-learned language model to obtain the prediction output, the method comprises:
obtaining, by the computing system, contextual weighting information descriptive of a plurality of context weights respectively associated with the plurality of contextual information elements; and
wherein processing the one or more inputs with the machine-learned language model comprises:
processing, by the computing system, the speech information and the plurality of contextual information elements with the machine-learned language model based at least in part on the plurality of context weights.

10. The computer-implemented method of claim 9, wherein the method further comprises:
determining, by the computing system, one or more weight adjustments for the plurality of context weights; and
applying, by the computing system, the one or more weight adjustments to the plurality of context weights.

11. The computer-implemented method of claim 10, wherein determining the one or more weight adjustments comprises:
determining, by the computing system, the one or more weight adjustments for the plurality of context weights based on a difference between the one or more second words and one or more ground-truth second words.

12. The computer-implemented method of claim 10, wherein determining the one or more weight adjustments comprises:
determining, by the computing system, a conversational length value indicative of a length of an ongoing conversation during which the user spoke the one or more first words; and
determining, by the computing system, the one or more weight adjustments for the plurality of context weights based on the conversational length value.

13. The computer-implemented method of claim 12, wherein determining the one or more weight adjustments for the plurality of context weights based on the conversational length value comprises:
making, by the computing system, a determination that the conversational length value is greater than a threshold value;
based on the determination, determining, by the computing system, the one or more weight adjustments for the plurality of context weights, wherein the one or more weight adjustments comprises:
a first weight adjustment to decrease a first context weight associated with the common language information element; and
a second weight adjustment to increase a second context weight associated with the historical user information element indicative of the speech patterns of the user.

14. The computer-implemented method of claim 5, wherein the plurality of contextual information elements comprises the geographic context information element descriptive of the geographic area that the user is associated with; and
wherein processing the speech information with the machine-learned language model further comprises;
identifying, by the computing system, a synonym for a particular word of the one or more second words, wherein the synonym is associated with the geographic area that the user is associated with, and wherein the particular word is associated with a second geographic area different than the first geographic area; and
replacing, by the computing system, the particular word with the synonym.

15. The computer-implemented method of claim 1, wherein, prior to processing the one or more inputs with the machine-learned language model to obtain the prediction output, the method comprises:
obtaining, by the computing system from a user device associated with the user, the speech information descriptive of the one or more first words spoken by the user from the user device.

16. The computer-implemented method of claim 15, wherein obtaining the speech information descriptive of the one or more first words spoken by the user from the user device comprises:
receiving, by the computing system, streaming audio data from the user device, wherein the streaming audio data comprises audio of the user speaking the one or more first words; and
processing, by the computing system, the streaming audio data with a machine-learned speech recognition model to obtain a speech-to-text output comprising the speech information.

17. A computing system, comprising:
a memory; and
one or more processor devices coupled to the memory to:
process one or more inputs with a machine-learned language model to obtain a prediction output, wherein the one or more inputs comprises speech information descriptive of one or more first words spoken by a user, and wherein the prediction output comprises one or more second words predicted to follow the one or more first words;
determining, by the computing system, a sequence of visemes formed to produce the one or more second words; and
based on the sequence of visemes, generate facial animation information descriptive of a facial animation that animates a three-dimensional representation of a mouth of the user forming the sequence of visemes to speak the one or more second words.

18. The computing system of claim 17, wherein determining the sequence of visemes formed to produce the one or more second words comprises:
extracting a sequence of phonemes from the one or more second words predicted to follow the one or more first words; and
for each phoneme of the sequence of phonemes:
mapping the phoneme to one or more visemes of the sequence of visemes formed to produce the phoneme.

19. The computing system of claim 17, wherein the computing system is further to:
provide the facial animation information to a user computing device associated with a second user different than the user.

20. A non-transitory computer-readable storage medium that includes executable instructions to cause one or more processor devices to:
process one or more inputs with a machine-learned language model to obtain a prediction output, wherein the one or more inputs comprises speech information descriptive of one or more first words spoken by a user, and wherein the prediction output comprises one or more second words predicted to follow the one or more first words;
determine a sequence of visemes formed to produce the one or more second words; and
based on the sequence of visemes, generate facial animation information descriptive of a facial animation that animates a three-dimensional representation of a mouth of the user forming the sequence of visemes to speak the one or more second words.
